(19) United States
(12) Patent Application Publication
(10) Pub. No.: US 2005/0090234 A1
(43) Pub. Date: Apr. 28, 2005

(54) Incoming call notification system and method

(75) Inventors: Akira Ioku, Tokyo (JP); Yoshiaki Morimoto, Kawasaki (JP); Motoaki Satoyama, Sagamihara (JP)

Correspondence Address: Hogan & Hartson;Biltmore Tower, Suite 1900, 500 South Grand Avenue, Los Angeles, CA, 90071, US

(73) Assignee: HITACHI, LTD.

(21) Appl. No.: 10/818,602

(22) Filed: Apr. 6, 2004

(30) Foreign Application Priority Data
Oct. 7, 2003 (JP) 2003-347765

(51) Int. Cl. H04M 3/42

(52) U.S. Cl. 455/412.2

(57) ABSTRACT

In an incoming call notification system for notifying of an incoming call when a call comes in to a portable terminal, an incoming call notification is simultaneously transmitted to devices available in the periphery, and each of the devices that receives the incoming call notification chooses to either accept or not accept the incoming call notification and determines the output method for the incoming call notification if the device chooses to accept the incoming call notification.

### BACKGROUND OF THE INVENTION

1. Field of the Invention

The present invention relates to an incoming call notification method of a portable terminal for notifying a user of an incoming call to the portable terminal.

2. Description of the Related Art

Incoming calls to a portable terminals such as a portable telephone are often unrecognized by the user. When a portable terminal is in a purse or luggage, or when the user is operating an information processing device such as a personal computer, the user's attention is not directed at the incoming call operation (output of ring tone, vibration, etc.) of the portable terminal, and the user may fail to notice the incoming call.

Various systems, method and devices have been proposed to address such a situation. For example, one of the systems notifies a music reproducing device of incoming calls to a portable telephone, a second system notifies a television set of incoming calls to a portable telephone, and a third system suggests a method and a device that do not limit the device that is alerted of incoming calls to a portable terminal device such as a portable telephone. The third system provides a portable terminal device and an incoming call notification method of the portable terminal device that can notify incoming calls in various modes using various types of external devices.

As described above, the first system notifies a music reproducing device of incoming calls to a portable telephone and the second system notifies a television set of incoming calls to a portable telephone, and both entail a limitation in that the device alerted of incoming calls to portable telephones is restricted to a music reproducing device or a television set.

In contrast, the method proposed in the third system does not limit the device that is alerted of incoming calls to a portable terminal device such as a portable telephone. A portable terminal device and an incoming call notification method of the portable terminal device proposed in the third system can notify incoming calls in various modes using various types of external devices.

According to the method in the third system, the external device that is to be selected varies depending on the conditions surrounding the portable terminal device, so that the external device that is selected as the external device to which an incoming call notification information is outputted varies depending on the conditions. As a result, since the incoming call notification mode depends on the functions available on the external device that is selected, the incoming call notification can be made in various modes using the external device.

However, according to the method in the third system, between the time that an incoming call is recognized and the time that an incoming call notification is sent by the portable terminal, a plurality of external devices are individually and sequentially searched, responses are received individually, and notification content is determined for each device; this can conceivably result in a negative side effect in which immediacy is likely to be lost by the time the incoming call notification is sent.

Furthermore, due to the fact that the processing for investigating the existence of external devices and determining the notification method is concentrated in the portable terminal, this method has the tendency for the processing load to concentrate on the portable terminal, or for the processing time to be amplified excessively, with an increase in the number of the external devices.

### SUMMARY OF THE INVENTION

In view of the above, the present invention relates to an incoming call notification method for notifying a portable terminal of incoming calls, which can be realized in a scalable and simple manner and which serves to notify a user quickly and reliably of the existence of incoming calls to the portable terminal.

In accordance with an embodiment of the present invention, in an incoming call notification method for notifying of an incoming call when a call comes in to a portable terminal, an incoming call notification is simultaneously transmitted to devices available in the periphery, and each of the devices that receives the incoming call notification chooses to accept or not to accept the incoming call notification, and determines an output method for outputting the incoming call notification.

“Simultaneous transmission” represents one-to-many (many-to-many) communications modes in general that are equivalent to broadcasting or multicasting in various communications standards. Since one communications node generally sends data to a plurality of other devices in such simultaneous transmission, the same data needs to be sent only once and data therefore can be distributed efficiently.

When an incoming call notification is sent in a simultaneous transmission according to the present invention, the amount of processing that takes place until the incoming call notification is sent is lessened and the processing time is shortened, since the operation for creating data and the operation for sending the data do not have to be repeated for each of the plurality of transmission destinations.

Furthermore, according to the present invention, due to the fact that the operation for deciding how to handle the incoming call notification, as well as the operation for outputting the incoming call notification to the user, are left up to the devices that receive the identical incoming call notification, the processing load is appropriately distributed among the receiving devices in the periphery from the portable terminal that sends the incoming call notification.

Consequently, according to the embodiment of the present invention, the time lag between the time when a call comes in to a portable terminal device and the time when an incoming call notification is sent is minimized, such that the time between the arrival of the incoming call at the portable terminal device until the user recognizes the incoming call can be shortened. In addition, since a processing load concentration on the portable terminal accompanied by an increase in the number of devices can be avoided and since the processing load can be appropriately distributed in the system, performance deterioration is difficult to occur even when the number of devices to which the incoming call notification is sent increases.

As a result, according to the embodiment of the present invention, a function for quickly notifying a user through devices in the periphery of an incoming call to a portable terminal can be efficiently realized.

According to the embodiment of the present invention, by minimizing the time lag between the time when a call comes in to a portable terminal device and the time when an incoming call notification is sent, the time that may be required until the user recognizes the incoming call can be shortened. In addition, since a processing load concentration on the portable terminal accompanied by an increase in the number of devices can be avoided and the processing load can be appropriately distributed in the system, performance deterioration is difficult to occur even when the number of devices to which the incoming call notification is sent increases. As a result, a function for quickly notifying a user through devices in the periphery of an incoming call to a portable terminal can be efficiently realized.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 shows a diagram of a system configuration in accordance with an embodiment of the present invention.

FIG. 2 shows a block diagram of a portable terminal in accordance with an embodiment of the present invention.

FIG. 3 shows a block diagram of an information processing device such as a personal computer in accordance with an embodiment of the present invention.

FIG. 4 shows a diagram of a communications frame for notifying of incoming calls (an incoming call information notification) in accordance with an embodiment of the present invention.

FIG. 5 shows a diagram of an incoming call data management section in accordance with an embodiment of the present invention.

### DESCRIPTION OF THE PREFERRED EMBODIMENT

Preferred embodiments of the present invention will be described with reference to the accompanying drawings.

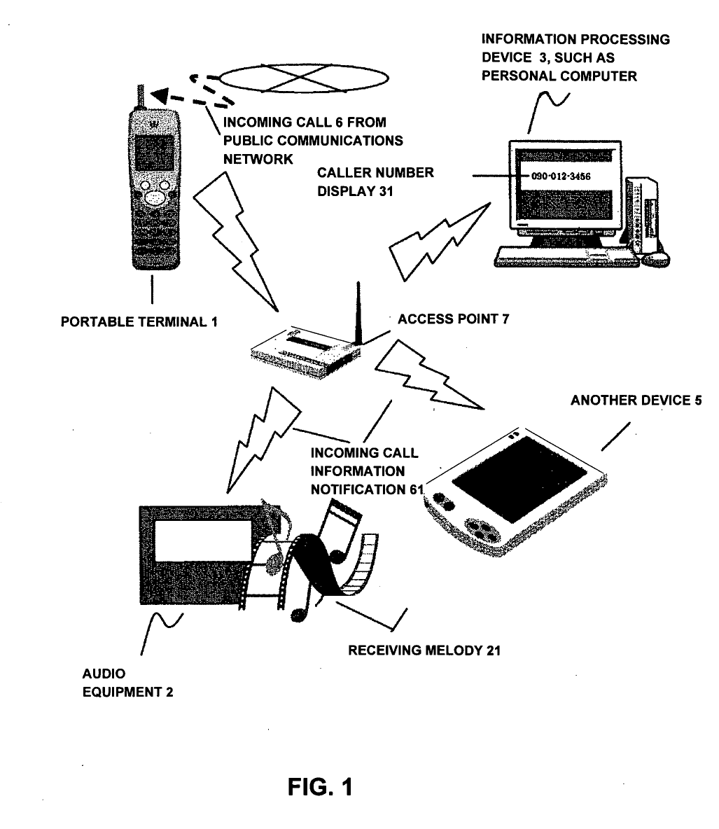

FIG. 1 shows a system configuration of an incoming call notification system in accordance with an embodiment of the present invention.

Referring to FIG. 1, wireless communications (local area communications) according to a predetermined wireless communications protocol is possible between a portable terminal 1 and an information processing device 3 such as a personal computer, as well as between the portable terminal 1 and an audio equipment 2. The same applies to the relationship between the portable terminal 1 and another device 5.

Upon receiving an incoming call 6 from a public communications network, the portable terminal 1 simultaneously broadcasts an incoming call information notification frame (an incoming call information notification 61) through wireless communications and notifies the information processing device 3 such as a personal computer, the audio equipment 2 and the other device 5.

“Simultaneous transmission” represents one-to-many communications modes in general that are equivalent to broadcasting or multicasting in various communications standards.

The incoming call information notification frame 61 is created by the portable terminal 1 that obtained an incoming call signal and serves to hold information concerning the inward call, such as, the caller's number.

In FIG. 1, an access point 7 is a device that could be a component when a wireless LAN or a local area closed wireless communications based on a short distance wireless communications standard (local area wireless communications), but especially the wireless LAN, is assumed to be the predetermined wireless communications procedure. In FIG. 1, the access point 7 functions as a relay point in the local area wireless communications.

FIG. 1 also shows, as an example of operations that take place on the receiving side of the incoming call information notification frame 61, a situation in which the information processing device 3 such as a personal computer outputs a caller number display 31, and the audio equipment 2 sounds a tone or a piece of music 21 that signifies an alert that an incoming call has arrived (e.g., a receiving melody).

Through these operations, the user of the portable terminal 1, who is currently operating the information processing device 3 such as a personal computer or the audio equipment 2, can immediately and clearly recognize the incoming call.

In addition to the information processing device 3 such as a personal computer and the audio equipment 2, the other device 5 can also be similarly treated as a recipient of the incoming call information notification frame 61 from the portable terminal 1.

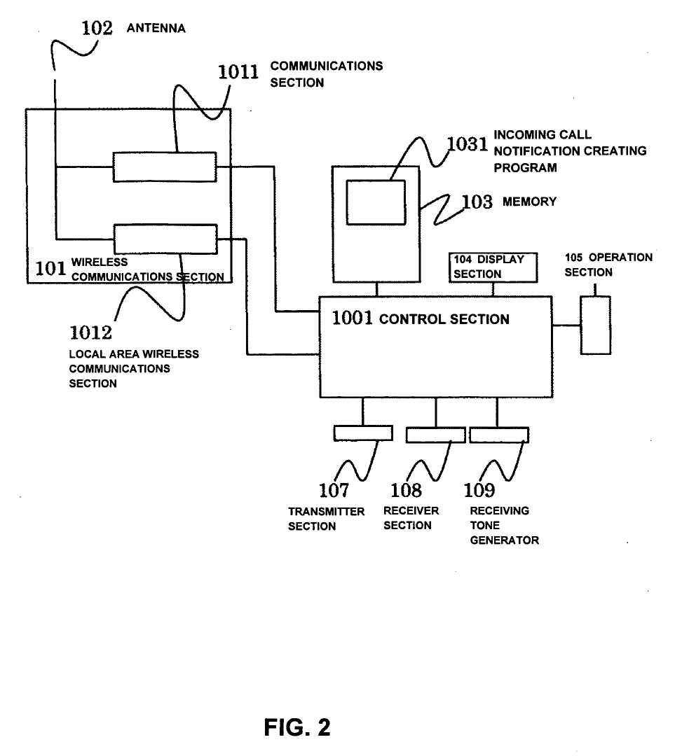

FIG. 2 shows an example configuration of the portable terminal 1 in the system.

In FIG. 2, the predetermined wireless communications protocol is assumed to be a wireless LAN or a local area closed wireless communications based on a short distance wireless standard (local area wireless communications).

The portable terminal 1 comprises components including a control section 1001, a wireless communications section 101, a communications section 1011 for public wireless communications network, an antenna 102, a memory 103, a display section 104, an operation section 105, a transmitter section 107, a receiver section 108, and a receiving tone generator 109. These components may be generally equivalent to those of an ordinary portable telephone.

In addition, in accordance with one feature of the embodiment of the present invention, the portable terminal 1 includes a local area wireless communications section 1012. The local area wireless communications section 1012 handles communications through wireless LAN or local area wireless communications according to a short distance wireless standard.

The display section 104 displays various types of information according to controls by the control section 1001. The operation section 105 is provided with an input device such as a ten-key keyboard, a numeric keypad, etc. for inputting various types of information. Voice signals and other types of information inputted through the operation section 105 are supplied to the control section 1001.

The communications section 1011 for public wireless communications network controls wireless communications with public networks.

For example, signals from a public network received by the antenna 102 are supplied to the control section 1001 via the communications section 1011 for public wireless communications network, and outputted from the display section 104 or the receiving tone generator 109 (as, for example, a receiving melody, a receiving tone, a ring tone or voice output) via the control section 1001.

Signals inputted from the operation section 105 are supplied to the communications section 1011 for public wireless communications network via the control section 1001, supplied from the communications section 1011 for public wireless communications network to the antenna 102, and sent to a public network.

The local area wireless communications section 1012 controls local area wireless communications with external devices. The local area wireless communications take place according to a predetermined communications protocol such as wireless LAN or short distance wireless standards, for example.

The information to be sent to external devices in a local area wireless communications area is transmitted from the control section 1001 to the local area wireless communications section 1012, and information received by the antenna 102 of the portable terminal 1 is transmitted to the control section 1001 via the local area wireless communications section 1012.

In one feature of the embodiment of the present invention, various functions of the incoming call notification system are controlled by an incoming call notification creating program 1031. The incoming call notification creating program 1031 may be stored in the memory 103, and is started by the control section 1001. The incoming call notification creating program has a function to create the incoming call information notification frame 61 that holds information concerning the inward call.

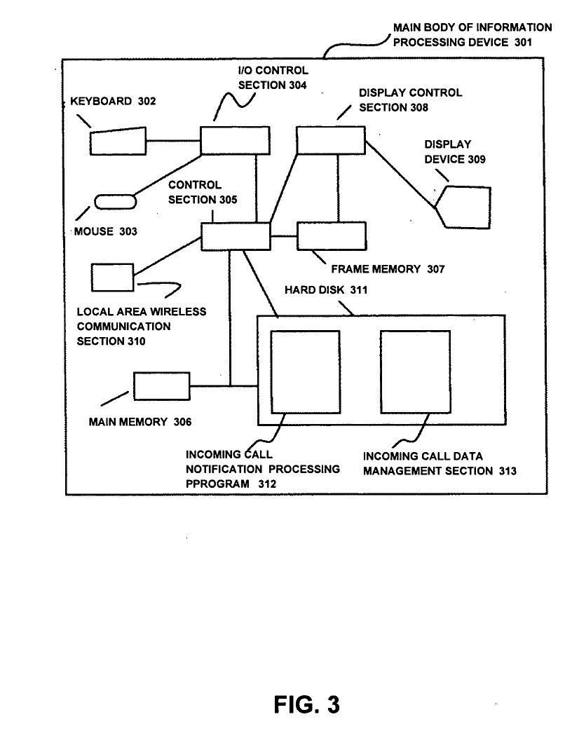

FIG. 3 shows an example configuration of the information processing device 3 such as a personal computer in accordance with an embodiment of the present invention as an example of a device that is connected through the local area wireless communications with the portable terminal 1.

As shown in FIG. 3, the information processing device 3 such as a personal computer is provided with a keyboard 302, a mouse 303, an I/O control section 304, a control section (in the personal computer) 305, a main memory 306, a frame memory 307, a display control section 308, a display device 309, and a hard disk device 311.

A local area wireless communications section (in the personal computer) 310 handles local area wireless communications through wireless LAN or short distance wireless standards.

The control section (in the personal computer) 305 executes programs stored in the main memory 306 to perform processings according to various instructions inputted by the user through the keyboard 302 or the mouse 303, develops display information obtained as processing results into bitmap data, and writes the bitmap data to the frame memory 307. The bitmap data written to the frame memory 307 is read by the display control section 308 and displayed on the display device 309.

The hard disk 311 stores an incoming call notification processing program 312 and an incoming call data management section 313.

The incoming call notification processing program 312 is loaded onto the main memory 306 for use, where it decodes the incoming call notification received from the portable terminal 1 using inputted information from the incoming call data management section 313 and performs processings according to the content of the incoming call notification received.

An example of the incoming call data management section 313 is shown in FIG. 5. In this example, the incoming call data management section 313 manages incoming call data by caller numbers. The incoming call data is loaded onto the main memory 306 and referred to by the incoming call notification processing program 312.

The following is a description of the operation according to the present embodiment example.

First, the procedure that takes place from the time when the portable terminal 1 receives an incoming call to the time when the portable terminal 1 simultaneously transmits an incoming call notification will be described. When a call comes in from a public network to the portable terminal 1 having the configuration described above, the communications section 1011 for public wireless communications network outputs an incoming call signal to the control section 1001.

Upon obtaining the incoming call signal, the control section 1001 starts the incoming call notification creating program 1031 and causes it to create an incoming call information notification frame 61. The incoming call notification creating program 1031 creates the incoming call information notification frame 61 and inserts information concerning the inward call in the incoming call information notification frame 61.

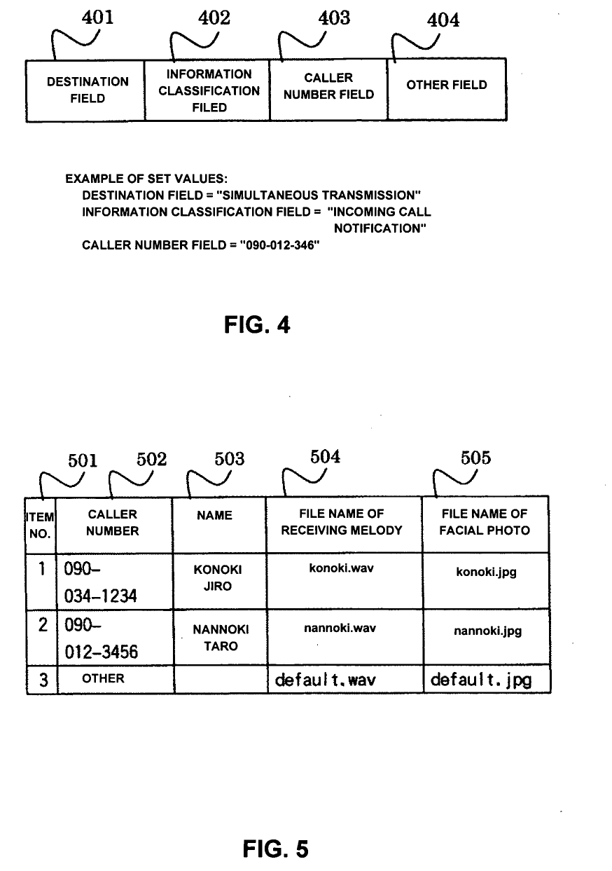

FIG. 4 is an example of the incoming call information notification frame 61 in accordance with an embodiment of the present invention. In this example, the incoming call notification creating program 1031 writes in a caller number field 403 of the incoming call information notification frame 61 the caller number (telephone number) that is included in the incoming call signal. The incoming call notification creating program 1031 also writes a setting that indicates “simultaneous transmission” in a destination field 401 and a setting that indicates “incoming call notification” in an information classification field 402. When these are written, the incoming call notification creating program 1031 is terminated.

Next, in order to send the incoming call information notification frame 61, the control section 1001 outputs to the local area wireless communications section 1012 a request to connect with external devices through the local area wireless communications.

The local area wireless communications section 1012 is assumed to be in a connected state with the access point 7 in the local area wireless communications.

The control section 1001 sends the incoming call information notification frame 61 to the access point 7 via the local area communications wireless communications section 1012 and the antenna 102.

“Simultaneous transmission” in the destination field 401 is recognized according to the wireless LAN standard, for example, and the incoming call information notification frame 61 is sent in a broadcast via the access point 7 to the devices in the periphery of the portable terminal 1.

Next, the procedure of processings performed by the receiving side of the incoming call notification that is simultaneously transmitted will be described below.

According to one embodiment of the present invention, receiving devices that actively utilize a caller number and receiving devices that abandon a caller number, depending on the properties and settings of the receiving devices, may co-exist for the same simultaneous transmission.

In one feature of the present invention, the operation in response to the incoming call notification may differ among different receiving devices as a result of each choosing to either accept or not accept the same incoming call notification that was simultaneously transmitted.

For this reason, separate procedures concerning information that is sent and provided as the incoming call notification will be described using as examples a device that skips (abandons) information such as a caller number and a device that utilizes and outputs information such as a caller number. The information processing device 3 such as a personal computer will be used as an example of the receiving device that utilizes and outputs information such as caller numbers, while the audio equipment 2 will be used as an example of the receiving device that skips (abandons) the information.

First, in the former example, i.e., the example in which information such as a caller number is actively utilized, the caller number, a name and a receiving melody that correspond to the caller number, and a facial photograph of the caller can be displayed.

A device that has ample secondary storage for storing caller numbers and corresponding music data and picture information as a set, such as a personal computer, is suitable as a device for realizing the above. For this reason, the information processing device 3 such as a personal computer would be the suitable device.

Upon receiving the incoming call information notification frame 61 in FIG. 4, that was simultaneously transmitted from the portable terminal 1, through the local area wireless communications section (in the personal computer) 310, the control section (in the personal computer) 305 of the personal computer reads the information classification field 402 of the incoming call information notification frame 61.

If the content of the information classification field 402 is “incoming call notification,” the control section (in the personal computer) 305 loads the incoming call notification processing program 312 from the hard disk 311 onto the main memory 306 and starts the program 312. The incoming call notification processing program 312 reads the caller number field 403.

If the caller number field 403 indicates “not notified,” the incoming call notification processing program 312 displays the character string “not notified” in the display device 309 via the display control section 308. Then, the incoming call notification processing program 312 is terminated.

On the other hand, if the caller number field 403 indicates “notified,” the incoming call notification processing program 312 reads various types of incoming call notification information (e.g., receiving melody, name and facial photograph of the caller) that correspond to the caller number (telephone number) included in the incoming call signal and that are managed by the incoming call data management section 313.

Next, using a number “090-012-3456” set in the caller number field 403 in FIG. 4, the procedure for outputting the corresponding receiving melody, the facial photograph of the caller and the name of the caller is described as an example. First, the incoming call notification processing program 312 reads the incoming call data management section 313. An example of the incoming call data management section 313 is shown in FIG. 5, which will be used in the description. The incoming call notification processing program 312 searches for “090-012-3456” (the value set in the caller number field 403 in FIG. 4) in a caller number column 502. The receiving melody that corresponds to this number in a receiving melody column 504 is “Nannoki (filename: nannoki.wav).” This is determined to be the corresponding receiving melody. The facial photograph is determined in a similar manner from a facial photograph column 505 to be the filename “nannoki.jpg.” The incoming call notification processing program 312 reads these files and displays the nannoki.jpg on the display device 309 via the display control section 308. The incoming call notification processing program 312 also outputs a receiving melody corresponding to the file receiving melody filename “nannoki.wav” through speakers, etc.

In addition, by searching a name column 503, the incoming call notification processing program 312 can also output on the display device 309 a character string “Nannoki Taro,” which corresponds to “090-012-3456” (the value set in the caller number field 403 in FIG. 4), as the name of the caller.

If an incoming call notification of a caller number that matches neither item number 1 nor item number 2 in FIG. 5 is received, item number 3 in FIG. 5 applies to the situation, and the incoming call notification processing program 312 accordingly outputs “name: other” and default.wav and default.jpg.

Not all devices are like the example described; in other words, not all devices have ample secondary storage for storing caller numbers and corresponding music data and picture information as sets. For example, the audio equipment 2 at present may have difficulty maintaining various types of data correlated to caller numbers.

In such devices, in one feature of the present embodiment example, only an alert of an incoming call may be made to the user, and information such as the caller number is ignored and discarded. Next, the processing procedure of a device that skips (abandons) the caller number in the incoming call notification information that is simultaneously transmitted from the portable terminal will be described.

Methods of alerting include outputting a notification sound through a headphone or outputting a notification sound through speakers. In either case, as one of the features of the present invention, the receiving device discards or does not use the caller number information, in other words, the caller number information is not reflected on the operation of the receiving device; other matters, such as setting items of a user setting file and operations other than the above may differ from the present example.

For example, assuming that the audio equipment 2 has an accessory device that has a vibrating function (e.g., a vibration part), a method for outputting the incoming call information through vibration without impeding the user's activity of listening to music reproduced is possible.

Through this, the user would be able to recognize the incoming call notification from a remote portable terminal without having the activity to listen and enjoy music reproduced impeded.

While the description above refers to particular embodiments of the present invention, it will be understood that many modifications may be made without departing from the spirit thereof. The accompanying claims are intended to cover such modifications as would fall within the true scope and spirit of the present invention.

For example, in the embodiment described above, the incoming call notification processing program 312 is realized by software, but in accordance with the present invention, the incoming call notification processing program can be implemented through a combination of hardware and software or by hardware alone. The present invention can be implemented through various programming languages.

In the embodiment described above, the example of the information processing device 3 such as a personal computer and the example of the audio equipment 2, regardless of whether information such as the caller number is utilized, both provide an output indicating that an incoming call notification was received (e.g., by displaying the caller number, or alerting the user of the audio equipment 2 through vibration of the existence of the incoming call even though the caller number is not outputted). However, settings that cause the entire incoming call notification not to be utilized (i.e., abandoned or ignored) depending on the purpose and/or circumstances of the devices present in the periphery are also possible.

In the embodiment described above, “simultaneous transmission” is described as representing one-to-many communications modes in general that are equivalent to broadcasting or multicasting in various communications standards, but the “simultaneous transmission” can also be applied to many-to-many communications methods.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. An incoming call notification system formed from a portable terminal that is connectable to a mobile public communications network, and at least one device that is communicable with the portable terminal through a communications path that is different from the mobile public communications network, the incoming call notification system comprising:
a receiving unit provided on the portable terminal that receives an incoming call from the mobile public communications network; and
a wireless communications unit that performs a simultaneous transmission of an incoming call notification concerning the incoming call from the portable terminal to the at least one device through the communications path that is different from the mobile public communications network.

2. An incoming call notification system according to claim 1, wherein the simultaneous transmission is one of a multicasting and a broadcasting.

3. An incoming call notification system according to claim 1, further comprising an incoming call notification creating module that creates an incoming call information notification frame, wherein the incoming call notification includes the incoming call information notification frame.

4. An incoming call notification system according to claim 3, wherein the incoming call notification creating module sets information concerning the incoming call in the incoming call information notification frame.

5. An incoming call notification system according to claim 1, wherein the wireless communications unit simultaneously transmits the incoming call notification to a plurality of devices that are present in a wireless communication range, and each of the plurality of devices determines as to whether or not the incoming call notification is to be accepted.

6. An incoming call notification system according to claim 5, wherein when one of the plurality of devices decides to accept the incoming call notification, the one of the plurality of devices performs a first action according to the incoming call notification.

7. An incoming call notification system according to claim 6, wherein when another one of the plurality of devices determines not to accept the incoming call notification, the another one of the plurality of devices performs a second action different from the first action.

8. An incoming call notification system according to claim 1, wherein the incoming call notification includes information concerning a caller, and the at least one device that receives the incoming call notification comprises a choosing module that chooses the information concerning the caller in the incoming call notification that is simultaneously transmitted.

9. An incoming call notification system formed from a portable terminal that is connectable to a first network through a first communications method, and at least one device that is communicable with the portable terminal through a second communications method that is different from the first communications method, the incoming call notification system comprising:
a receiving unit that receives an incoming call from the first network; and
a communications unit that performs a simultaneous transmission of an incoming call notification concerning the incoming call to the at least one device through the second communications path.

10. An incoming call notification system according to claim 9, wherein the simultaneous transmission is one of a multicasting and a broadcasting.

11. An incoming call notification system according to claim 9, further comprising an incoming call notification creating module that creates an incoming call information notification frame, wherein the incoming call notification includes the incoming call information notification frame.

12. An incoming call notification system according to claim 11, wherein the incoming call notification creating module sets information concerning the incoming call in the incoming call information notification frame.

13. An incoming call notification system according to claim 9, wherein the communications unit simultaneously transmits the incoming call notification to a plurality of devices that are present in a wireless communication range, and each of the plurality of devices determines as to whether or not the incoming call notification is to be accepted.

14. An incoming call notification system according to claim 13, wherein when one of the plurality of devices decides to accept the incoming call notification, the one of the plurality of devices performs a first action according to the incoming call notification.

15. An incoming call notification system according to claim 14, wherein when another one of the plurality of devices determines not to accept the incoming call notification, the another one of the plurality of devices performs a second action different from the first action.

16. An incoming call notification system according to claim 9, wherein the incoming call notification includes information concerning a caller, and the at least one device that receives the incoming call notification comprises a choosing module that chooses the information concerning the caller in the incoming call notification that is simultaneously transmitted.

17. A method for operating an incoming call notification system that is formed from a portable terminal that is connectable to a mobile public communications network, and at least one device that is communicable with the portable terminal through a communications path that is different from the mobile public communications network, the method comprising the steps of:
receiving an incoming call from the mobile public communications network; and
performing a simultaneous transmission of an incoming call notification concerning the incoming call from the portable terminal to the at least one device through the communications path that is different from the mobile public communications network.

18. A method for operating an incoming call notification system according to claim 17, wherein the simultaneous transmission is one of a multicasting and a broadcasting.

19. A method for operating an incoming call notification system according to claim 17, further comprising the step of creating an incoming call information notification frame, wherein the incoming call notification includes the incoming call information notification frame.

20. A method for operating an incoming call notification system according to claim 19, wherein the step of creating the incoming call information notification frame includes the step of setting information concerning the incoming call in the incoming call information notification frame.

21. A method for operating an incoming call notification system according to claim 17, wherein a plurality of devices that are present in a wireless communication range receive the incoming call notification that is simultaneously transmitted, and each of the plurality of devices determines as to whether or not the incoming call notification is to be accepted.

22. A method for operating an incoming call notification system according to claim 21, wherein when one of the plurality of devices decides to accept the incoming call notification, the one of the plurality of devices performs a first action according to the incoming call notification.

23. A method for operating an incoming call notification system according to claim 22, wherein when another one of the plurality of devices determines not to accept the incoming call notification, the another one of the plurality of devices performs a second action different from the first action.
